(19) United States
(12) Patent Application Publication
(10) Pub. No.: US 2025/0227455 A1
(43) Pub. Date: Jul. 10, 2025

(54) DYNAMIC MANAGEMENT OF A RESERVE eSIM FOR A WIRELESS DEVICE

(71) Applicant: Apple Inc., Cupertino, CA (US)

(72) Inventors: Abishek Kumar VAIDYANATHAN, Union City, CA (US); Keizo MARUI, New Dundee (CA); Li LI, Los Altos, CA (US); Mohanasundaram KATTAVOOR SIVAKUMAR, Mountain View, CA (US); Nithish Kulur PRABHAKARA, Sunnyvale, CA (US)

(21) Appl. No.: 18/909,672

(22) Filed: Oct. 8, 2024

Related U.S. Application Data
(60) Provisional application No. 63/619,661, filed on Jan. 10, 2024.

(51) Int. Cl. H04W 8/20; H04W 12/08; H04W 12/72; H04W 76/10

(52) U.S. Cl. CPC H04W 8/20; H04W 12/08; H04W 12/72; H04W 76/10

(57) ABSTRACT

This application sets forth techniques for dynamically managing a reserve electronic subscriber identity module (eSIM) for a wireless device. A reserve eSIM is installed in the wireless device to provide a limited functionality connectivity option for essential services, such as device activation, user eSIM provisioning, and user subscription account management. The reserve eSIM is reconfigured between an inactive state and an active state dynamically based on network conditions and application requirements for connectivity.

### CROSS-REFERENCE TO RELATED APPLICATIONS

The present application claims the benefit of U.S. Provisional Application No. 63/619,661, entitled “DYNAMIC MANAGEMENT OF A RESERVE eSIM FOR A WIRELESS DEVICE,” filed Jan. 10, 2024, the content of which is incorporated by reference herein in its entirety for all purposes.

### FIELD

The described embodiments set forth techniques for dynamically managing a reserve electronic subscriber identity module (eSIM) for a wireless device. A reserve eSIM is installed in the wireless device to provide a limited functionality connectivity option for essential services, such as device activation, user eSIM provisioning, and user subscription account management. The reserve eSIM is reconfigured between an inactive state and an active state dynamically based on network conditions and application requirements for connectivity.

### BACKGROUND

Newer generation, fifth generation (5G), cellular wireless networks that implement one or more 3rd Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device can include a reserve eSIM, also referred to as a bootstrap eSIM, a backup eSIM, or a provisioning eSIM, installed at a time of manufacture or provided dynamically to the wireless device thereafter. The reserve eSIM provides a limited functionality connectivity option to allow the wireless device to connect to a cellular wireless network for essential services, such as upon initial device activation or device configuration following a factory reset procedure. Additional conditions exist where availability to use the reserve eSIM can prove useful. There exists a need for mechanisms to manage dynamically a reserve eSIM to allow for network connectivity via the reserve eSIM to one or more applications under special circumstances.

### SUMMARY

This Application sets forth techniques for dynamically managing a reserve electronic subscriber identity module (eSIM) for a wireless device. A reserve eSIM is installed in the wireless device to provide a limited functionality connectivity option for essential services, such as during device activation or reconfiguration, user eSIM provisioning, user cellular wireless subscription account management, and the like. The reserve eSIM is reconfigured between an inactive state and an active state dynamically based on one or more monitored network conditions and one or more application requirements for network connectivity.

A wireless device includes a reserve eSIM, also referred to as a bootstrap eSIM, a backup eSIM, or a provisioning eSIM, installed at a time of manufacture or provided dynamically to the wireless device thereafter. The reserve eSIM provides a limited functionality connectivity option to allow the wireless device to connect to a cellular wireless network for a limited set of services, such as to connect to original equipment manufacturer (OEM) servers for device activation, to connect to mobile network operator (MNO) servers to provision, download and install a full functionality user eSIM, to connect to MNO servers to manage a cellular wireless subscription account, or the like. The reserve eSIM can be in an inactive state, where the inactive state restricts the wireless device from establishing a connection with the cellular wireless network via the reserve eSIM until activated. The wireless device monitors one or more conditions that indicate use of the reserve eSIM may be warranted. Exemplary conditions can include when a user eSIM is installed but not yet activated, when cellular connectivity via an installed user eSIM is unavailable, when cellular connectivity via a user eSIM is only available via a roaming network, when Internet connectivity is unavailable via a non-cellular wireless connection, or the like. The wireless device provides a recommendation for use of the reserve eSIM to one or more applications authorized to use the reserve eSIM responsive to determining that one or more conditions to use the reserve eSIM are satisfied. The wireless device reconfigures the reserve eSIM from the inactive state to an active state in response to a network connection request to establish a cellular wireless network connection from an application of the one or more authorized applications. The wireless device attaches to a cellular wireless network via the reserve eSIM and establishes a cellular wireless network connection via the reserve eSIM for the application. The wireless device reconfigures the reserve eSIM from the active state to the inactive state after detecting use of the cellular wireless network has completed and no conditions to use the reserve eSIM are satisfied.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates an exemplary device activation and provisioning network for a wireless device, according to some embodiments.

FIG. 4A illustrates an exemplary state diagram for a reserve eSIM, according to some embodiments.

FIG. 4B illustrates an exemplary activation flow for use of a reserve eSIM, according to some embodiments.

FIG. 5 illustrates an exemplary reserve eSIM management system of a wireless device, according to some embodiments.

FIG. 6 illustrates an example of management of a reserve eSIM by a wireless device, according to some embodiments.

FIG. 7 illustrates an exemplary method for dynamic management of a reserve eSIM on a wireless device, according to some embodiments.

FIG. 8 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques for dynamically managing a reserve electronic subscriber identity module (eSIM) for a wireless device. A reserve eSIM is installed in the wireless device to provide a limited functionality connectivity option for essential services, such as during device activation or reconfiguration, user eSIM provisioning, user cellular wireless subscription account management, and the like. The reserve eSIM is reconfigured between an inactive state and an active state dynamically based on one or more monitored network conditions and one or more application requirements for network connectivity.

A wireless device includes a reserve eSIM, also referred to as a bootstrap eSIM or provisioning eSIM, installed at a time of manufacture or provided dynamically to the wireless device thereafter. The reserve eSIM provides a limited functionality connectivity option to allow the wireless device to connect to a cellular wireless network for a limited set of services, such as to connect to original equipment manufacturer (OEM) servers for device activation, to connect to mobile network operator (MNO) servers to provision, download and install a full functionality user eSIM, to connect to MNO servers to manage a cellular wireless subscription account, or the like. The wireless device can include non-cellular wireless capability; however, the wireless device may be operating at a location where non-cellular wireless connections with Internet connectivity are unavailable or unable to be established for the wireless device. The reserve eSIM can be in an inactive state, where the inactive state restricts the wireless device from establishing a connection with the cellular wireless network via the reserve eSIM until activated. The wireless device monitors one or more conditions that indicate use of the reserve eSIM may be warranted. Exemplary conditions can include when a user eSIM is installed but not yet activated, when cellular connectivity via an installed user eSIM is unavailable, when cellular connectivity via a user eSIM is only available via a roaming network, when Internet connectivity is unavailable via a non-cellular wireless connection, or the like. Specific conditions that warrant use of the reserve eSIM can be device dependent, e.g., a mobile phone may have different conditions for use of the reserve eSIM than a tablet computing device. Conditions to allow use of the reserve eSIM can depend on configuration of the wireless device, e.g., based on whether a user setting for data roaming is enabled or disabled when cellular connectivity is available only via a roaming network.

A dynamic reserve eSIM management module in the wireless device can monitor for various network conditions and determine based on the network conditions whether use of the reserve eSIM is warranted. The dynamic reserve eSIM management module can obtain network registration status from a network registration controller, roaming status from a roaming controller, eSIM status from a subscription controller, and/or network connection information and network probe results from a network monitoring service. A network monitoring service of the wireless device can determine status of network connectivity, such as monitoring for stalled data transfer conditions, checking Internet connectivity, sending probe packets to test connectivity, etc. In some cases, the dynamic reserve eSIM management module can determine that conditions to use the reserve eSIM are satisfied when wireless connectivity is available but performance is inadequate for one or more applications. The dynamic bootstrap management module of the wireless device can provide a recommendation for use of the reserve eSIM to one or more applications authorized to use the reserve eSIM responsive to determining that one or more conditions to use the reserve eSIM are satisfied. In some cases, one or more applications installed on the wireless device can be entitled to use the reserve eSIM and can register for notification when the reserve eSIM is allowed to be enabled. Entitlement to use a reserve eSIM can be included in an application p-list that summarizes capabilities for the application.

An authorized application can determine whether to assert use of the reserve eSIM and establish a cellular wireless connection via the reserve eSIM when a recommendation for use of the reserve eSIM exists. The wireless device reconfigures the reserve eSIM from the inactive state to an active state in response to a network connection request to establish a cellular wireless network connection from an application of the one or more authorized applications. The wireless device attaches to a cellular wireless network via the reserve eSIM and establishes a cellular wireless network connection via the reserve eSIM for the application. In some cases, use of the reserve eSIM cellular wireless network connection can be limited to particular functions or to particular destination endpoints. For example, the wireless device can permit that application to use the wireless connection via the reserve eSIM to provision of a new user eSIM or to manage a cellular wireless service subscription account associated with an installed user eSIM, such as to refill a data allowance, cancel a subscription, purchase a new subscription, or the like. In some cases, use of the reserve eSIM can be extended to applications with pre-paid data connectivity when a user eSIM or non-cellular wireless connectivity is otherwise unavailable. The dynamic reserve eSIM management module can continue monitoring for conditions to use the reserve eSIM once activated. The wireless device can reconfigure the reserve eSIM from the active state to the inactive state after detecting use of the cellular wireless network has completed and no conditions to use the reserve eSIM are satisfied. In some cases, the dynamic reserve eSIM management module rescinds a recommendation for use of the eSIM or provides an indication that use of the reserve eSIM is not available to the one or more applications authorized to use the reserve eSIM. In some cases, the dynamic reserve eSIM management module waits until expiration of a timer expires after no conditions to use the reserve eSIM are satisfied before inactivating use of the reserve eSIM.

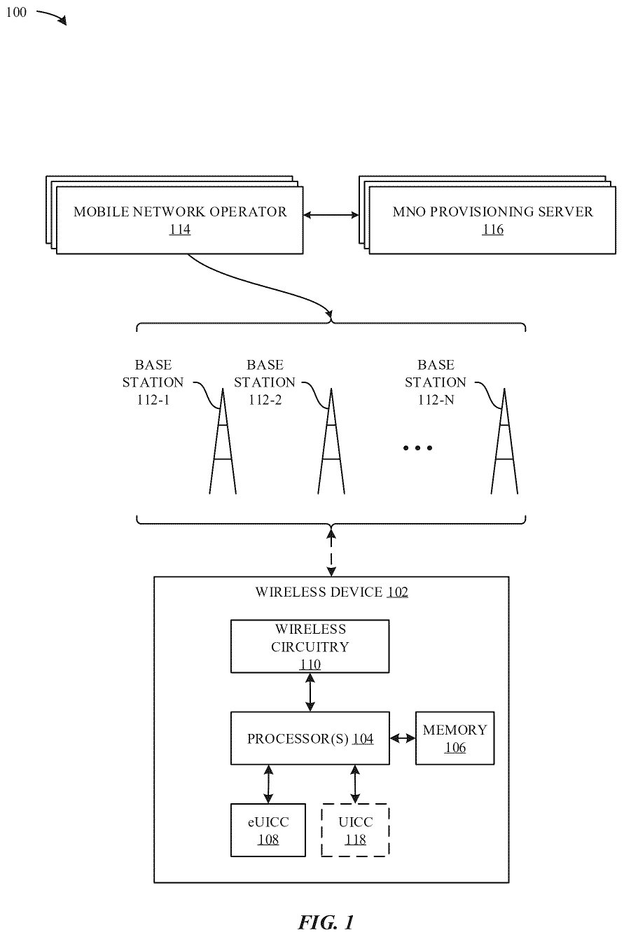

These and other embodiments are discussed below with reference to FIGS. 1-8; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and wireless circuitry 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, wireless circuitry 110, and UICC 118) can be arranged and combined in any number of configurations.

To be able to access services provided by an MNO, an eSIM can be reserved for subsequent download and installation to the eUICC 108. In some embodiments, the eUICC 108 obtains one or more eSIMs from one or more associated provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

In some cases, the wireless device 102 can lack an activated, fully functional cellular wireless eSIM on the eUICC 108 and can also not include a UICC 118 with an activated physical SIM (pSIM) installed in the wireless device 102. The user of the wireless device 102 can be required to activate, download, and/or configure a fully functional eSIM from an MNO provisioning server 116 to access cellular wireless services of a particular MNO with which the user establishes a cellular wireless subscription. The wireless device 102 can include a limited functionality reserve eSIM that can be initially configured in an inactive state. When an application authorized to use the reserve eSIM requires a wireless network connection, and no cellular wireless network connection or non-cellular wireless network connection is available or able to be established, the wireless device 102 can reconfigure the reserve eSIM from the inactive state to an active state to allow for establishing connections to a cellular wireless network via the reserve eSIM.

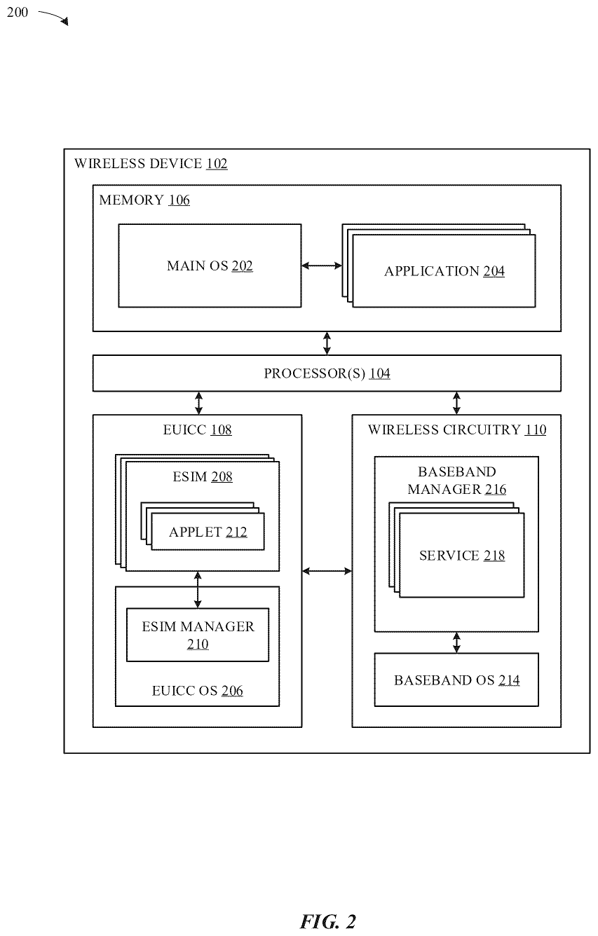

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the wireless circuitry 110 of the wireless device 102, which can include a baseband processor, can include a baseband OS 214 that is configured to manage hardware resources of the wireless circuitry 110 (e.g., a processor, a memory, different radio components, etc.). According to some embodiments, one or more components of the wireless circuitry 110, such as a baseband processor, can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. For a reserve eSIM 208 that provides limited functionality restricted to certain data connections when certain conditions are satisfied, e.g., when a cellular wireless connection via a user eSIM 208 or a non-cellular wireless connection with Internet connectivity is unavailable, the wireless device 102 can recommend to one or more authorized applications availability of the reserve eSIM. The wireless device 102 can reconfigure the reserve eSIM 208 from an inactive state to an active state, e.g., in response to an authorized application request for a network connection via the reserve eSIM. An applications processor, e.g., one of the processors 104, of the wireless device 102 can include modules to monitor for network conditions that warrant use of the reserve eSIM 208 and dynamically manage availability of the reserve eSIM for one or more applications. When conditions are satisfied to use the reserve eSIM 208, the reserve eSIM 208 can be recommended to one or more authorized applications. When conditions are not satisfied to use the reserve eSIM 208, the reserve eSIM 208 can be reconfigured to an inactive state from the active state.

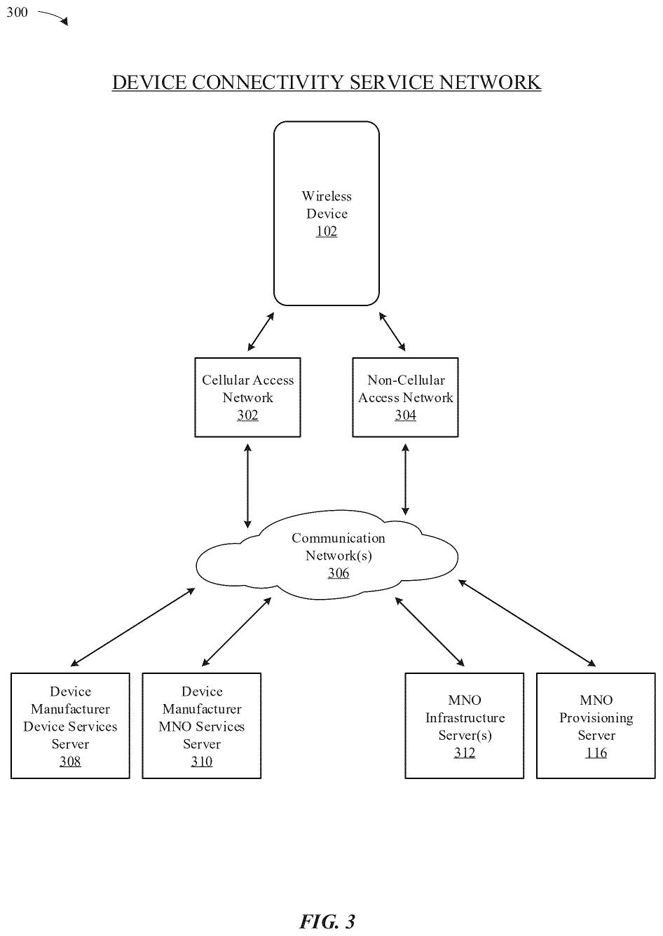

FIG. 3 illustrates a diagram 300 of elements of communication network involved in device activation and SIM provisioning, installation, and activation for a wireless device 102. Data connectivity for the wireless device 102 can be required for device activation and SIM provisioning. In some scenarios, a non-cellular access network 304 can be available for the wireless device 102 to connect to various device manufacturer managed and/or MNO 114 managed servers via intervening communication networks 306. In some scenarios, a non-cellular access network 304 may be not available, and the wireless device 102 may rely on access to a cellular access network 302 for activation of the wireless device 102 and/or for SIM provisioning, e.g., downloading and installation of a user eSIM 208, to the wireless device 102. In some embodiments, the wireless device 102 includes a limited functionality SIM profile, e.g., a pre-installed limited functionality reserve eSIM 208, which can provide limited access to the cellular access network 302, such as for provisioning a user eSIM 208 or to interact with MNO servers for managing a cellular wireless service subscription account. Use of the reserve eSIM 208 can be based on monitored network conditions and recommended for use to particular applications authorized to use the reserve eSIM 208. An OEM manufacturer of the wireless device 102 can maintain multiple network-based servers to assist with management of the wireless device 102, e.g., a device manufacturer managed device services server 308, which can provide management for device manufacturer supplied services to the wireless device 102, and a device manufacturer managed MNO services server 310, which can provide a device manufacturer anchor for management of MNO supplied services to the wireless device 102. An MNO 114 can also provide their own set of servers, including various MNO infrastructure servers 312 for managing cellular access, authentication, authorization, subscription, billing, and other associated management functions for cellular wireless services for the wireless device 102, and MNO provisioning servers 116 from which SIM firmware, e.g., eSIMs 208, OTA updates for eSIMs 208, etc., can be accessed, with appropriate authentication, by the wireless device 102.

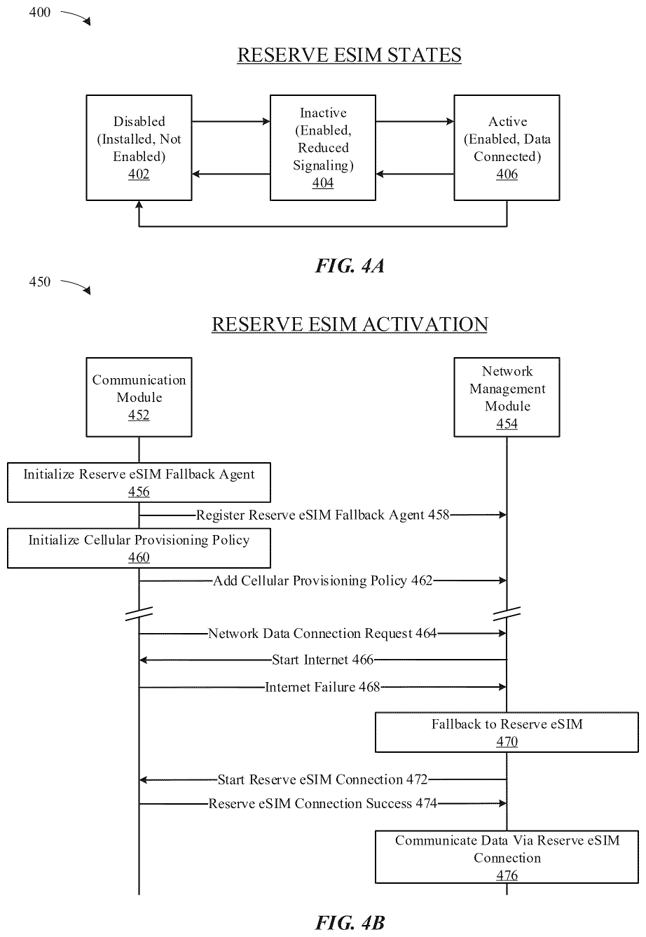

FIG. 4A illustrates a diagram 400 of exemplary states for a reserve eSIM 208 for a wireless device 102. The reserve eSIM 208 can be installed in the wireless device 102 at a manufacturing facility or downloaded to the wireless device 102 after manufacture. The reserve eSIM 208 can be installed on an eUICC 108 of the wireless device 102 can be configured in a disabled state 402. The reserve eSIM 208 cannot be used until being enabled. The reserve eSIM 208 can be reconfigured from the disabled state 402 to an inactive state 404 in which cellular wireless capabilities using the reserve eSIM 208 can be restricted from establishing an active cellular wireless connection with a cellular wireless network, e.g., to reduce signaling and to conserve battery power of the wireless device 102. The inactive state can include i) a cellular airplane mode in which a baseband cellular wireless transceiver is disabled (no cellular wireless transmissions or reception allowed) or ii) a limited network search mode in which a baseband cellular wireless receiver listens for signals from cellular wireless networks to ready the wireless device 102 for future cellular wireless connections but does not transmit or connect to the cellular wireless network using the reserve eSIM while in the inactive state. The reserve eSIM 208 can be reconfigured from the inactive state 404 to an active state 406 in which a data connection can be established with a cellular wireless network via the reserve eSIM 208. The wireless device 102 can cause the reserve eSIM 208 to enter and to exit the inactive state 404 based on requests from applications that are authorized to use the reserve eSIM 208. In some cases use of a cellular wireless connection via the reserve eSIM 208 can be restricted to a particular set of allowed actions, e.g., to allow for an Internet connection to a device manufacturer managed server for device activation, to enable a secure connection to an MNO 114 provisioning server 116 to download a user eSIM 208, to communicate status of various eSIM provisioning operations to a device manufacturer server or to an MNO server, or the like.

Client applications or system resources of the wireless device 102 that are authorized to use the reserve eSIM 208 can receive an indication of availability of the reserve eSIM 208. A client application or system resource can determine whether to request a network connection via the reserve eSIM 208 when available and can assert a requirement for use of the reserve eSIM 208, e.g., to a dynamic reserve eSIM management module. The client application or system resource can indicate completion of use the reserve eSIM 208 assertion when no longer required. When no applications or system resources authorized to use the reserve eSIM 208 require use of the reserve eSIM, the dynamic reserve eSIM management module can reconfigure the reserve eSIM 208 from the active state to the inactive state. The reserve eSIM 208 can remain available for authorized client applications and/or authorized system resources when certain conditions are satisfied.

FIG. 4B illustrates a diagram 450 of an exemplary use of a reserve eSIM 208 installed on an eUICC 108 of a wireless device 102. A communication module 452, which can execute on a processor 104 of the wireless device 102, such as an applications processor or a baseband processor, at 456, can initialize a reserve eSIM fallback agent associated with a reserve eSIM 208. At 458, the communication module 452 can register the reserve fallback agent with a network management module 454, which can also execute on the same processor 104 or another processor 104 of the wireless device 102. At 460, the communication module 452 can initialize a cellular provisioning policy to indicate proper use of the reserve eSIM 208 via the reserve fallback agent. At 462, the communication module 452 can communicate the cellular provisioning policy to the network management module. Subsequently, at 464, the communication module 452 can determine a requirement for a network data connection, e.g., based on a user input action or on a system resource requirement, and can communicate a network data connection request to the network management module 454. In some embodiments, the network management module 454, can be unaware of the inactive state 404 for the reserve eSIM 208. At 466, the network management module 454 can send a request to the communication module 452 to initiate an Internet data connection, e.g., by establishing a non-cellular wireless connection or a cellular wireless connection based on a user eSIM 208. At 452, the communication module 452 can respond to the network management module 454 indicating failure to establish the requested Internet data connection, which can occur when no non-cellular wireless connection can be established and no user eSIMs 208 are installed and enabled on the eUICC 108 of the wireless device 102. At 470, the network management module 454 can fallback to use of the reserve eSIM 208, e.g., in accordance with the cellular provisioning policy received previously from the communication module 452 at 462. At 472, the network management module 454 can send a message to the communication module 452 to establish a network connection using the reserve eSIM 208. At 474, the communication module 452 can respond with an indication of successful establishing of a network connection using the reserve eSIM 208. At 476, the network management module 454 can communicate data via the connection established using the reserve eSIM 208. In some embodiments, as illustrated in FIG. 4B, a provisioning eSIM 208 capability is available for a data connection when no other data connection is available and used as a fallback connection on-demand.

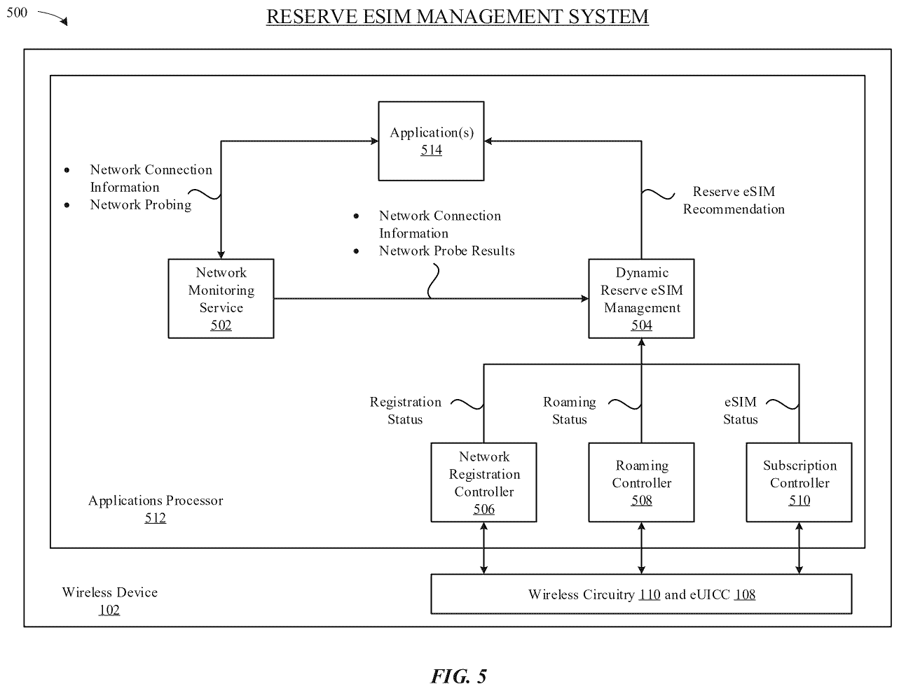

FIG. 5 illustrates a diagram 500 of an exemplary reserve eSIM 208 management system for a wireless device 102. The wireless device 102 includes an applications processor 512 that communicates with the wireless circuitry 110 and eUICC 108 of the wireless device 102 to manage a reserve eSIM 208 installed on the eUICC 108 of the wireless device 102. A dynamic reserve eSIM management module 504 of an applications processor 512 of the wireless device 102 can monitor networking conditions and status information to determine whether to recommend use of a reserve eSIM 208 to one or more applications or system resources authorized to use the reserve eSIM 208. The dynamic reserve eSIM management module 504 can monitor network connection information provided by a network monitoring service module 502, which communicates with one or more applications 514 to ascertain the network connection information. In some embodiments, the network monitoring service module 502 can monitor network connection establishment successes and failures, e.g., for a transport control protocol (TCP) connection and/or for a transport level security (TLS) session, and/or network connection performance results across multiple applications of the wireless device 102. In some cases, when network connection information indicates consistent network connection failures over a continuous time period that satisfies a failure time threshold, the network monitoring service module 502 can initiate a probe procedure to check the health of network connectivity for the wireless device 102. In some embodiments, the network monitoring service module 502 can cause the wireless device 102 to transmit a number of echo user datagram protocol (UDP) packets to a known network endpoint and monitor for resulting return packets. The network monitoring service module 502 can provide results of the network probe procedure to one or more client applications. The network monitoring service module 502 can also provide the results of the network probe procedure to the dynamic reserve eSIM management module 504, which can recommend use of the reserve eSIM 208 based at least in part on unsuccessful network probe results.

The dynamic reserve eSIM management module 504 can also monitor status associated with various eSIMs 208 (and in some cases pSIMs) such as i) registration status for registration with a cellular wireless network associated with an eSIM 208 provided by a network registration controller module 506, ii) roaming status from a roaming controller module 508, and eSIM status from a subscription controller module 510, where each of the modules 506, 508, 510 are communication with the eUICC 108 and/or the wireless circuitry 110 of the wireless device 102. In some cases, the dynamic reserve eSIM management module 504 recommends use of a reserve eSIM 208 when a “cold”, e.g., yet to be activated, user eSIM 208 is installed on the eUICC 108 of the wireless device 102, and no cellular wireless connection via another user eSIM 208 or non-cellular wireless connection is available to activate the cold user eSIM 208. Additional examples of a cold eSIM 208 include: i) a pre-paid eSIM 208 without any data or time-use allocation available, and ii) an eSIM 208 that can attach to a cellular wireless network but is not configured to establish a data connection or is not usable for communicating data for a particular activity. In some cases, the dynamic reserve eSIM management module 504 can consider a device configuration for one or more eSIMs 208 to determine whether to recommend use of a reserve eSIM 208 for an application 514. For example, the wireless device can be configured to use a particular eSIM 208 for cellular data communication and can also be configured to disallow switching data connectivity between different eSIMs 208, e.g., from a personal eSIM 208 to an enterprise eSIM 208 or vice versa. In some cases, the dynamic reserve eSIM management module 504 can determine to recommend use of a reserve eSIM 208 when a data-preferred eSIM 208 is not able to be used for data communication and switching between eSIMs 208 is disallowed. A user of the wireless device 102 can prefer to manage the data-preferred eSIM 208 or acquire a new eSIM 208 (e.g., when roaming) when an application authorized to use the reserve eSIM 208 requires data connectivity and the data-preferred eSIM 208 cannot be used.

In some cases, the dynamic reserve eSIM management module 504 can consider an indication of stalled data to determine an adequate wireless connection may be unavailable and use of the reserve eSIM 208 for an authorized application may be warranted. In some embodiments, the network monitoring service module 502 can listen to information regarding network software stacks to determine whether i) non-cellular wireless connectivity is available, ii) cellular wireless connectivity is available, and/or iii) the Internet is reachable via wireless connections and provide information of this network monitoring to the dynamic reserve eSIM management module 504 to use to determine whether to recommend use of a reserve eSIM 208.

Applications 514 can include a p-list that indicates capabilities that the application is authorized to use, which in some cases can include use of the reserve eSIM 208. In some cases availability to use the reserve eSIM 208 can be preconfigured in the application 514. The dynamic reserve eSIM management module 504 can be aware of which applications 514 (and also system resources) that are authorized for use of the reserve eSIM 208. When conditions are satisfied to use the reserve eSIM 208, the dynamic reserve eSIM management module 504 can recommend use of the reserve eSIM 208 to one or more authorized applications and/or authorized system resources. An authorized application (or authorized system resource) can subsequently request establishment of a network connection via the reserve eSIM 208 after being provided the recommendation. In some cases the applications processor 512 can check for validity of an application requesting use of the reserve eSIM 208 before allowing a network connection via the reserve eSIM 208 to be established for the application. When no applications authorized to use network connections via the reserve eSIM 208 require use of the reserve eSIM 208 for a continuous period of time that satisfies a time threshold, the dynamic reserve eSIM management module 504 can return the reserve eSIM 208 to an inactive state an withdraw recommendation for use of the reserve eSIM 208, e.g., by sending an indication that the reserve eSIM 208 is not available for use. When network conditions and/or combinations of registration status, roaming status, and/or eSIM status indicate that use of the reserve eSIM is warranted, the dynamic reserve eSIM management module 504 can again recommend to one or more authorized applications that use of a reserve eSIM 208 is available.

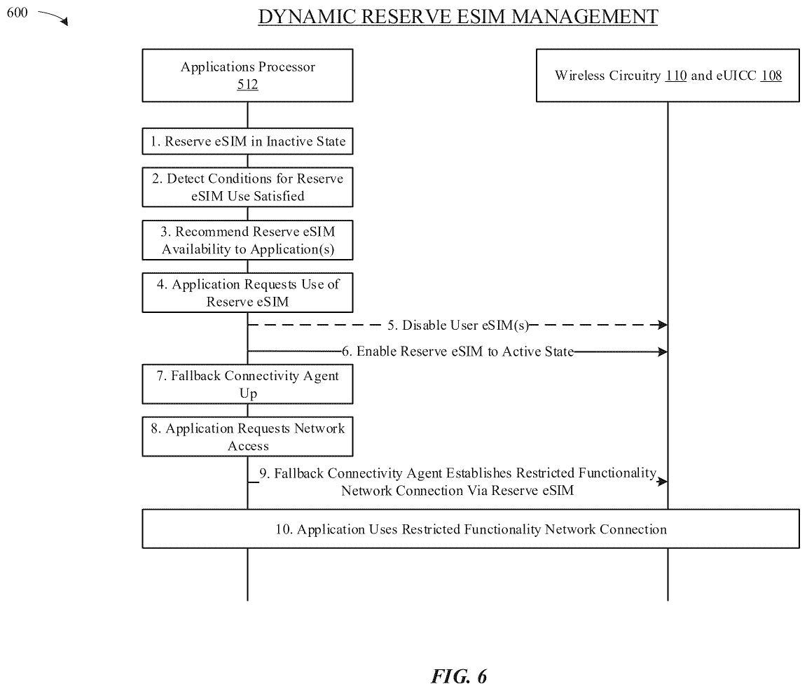

FIG. 6 illustrates a diagram 600 of an example of actions taken to manage dynamically a reserve eSIM 208 by elements of a wireless device 102. Initially, a reserve eSIM 208 on an eUICC 108 of the wireless device 102 can be in an inactive state, e.g., configured via the eUICC 108 by a dynamic reserve eSIM management module 504 in the applications processor 512 of the wireless device 102. The dynamic reserve eSIM management module 504 can detect conditions for use of a reserve eSIM 208 are satisfied and recommend to one or more applications 514, authorized to use network connections via the reserve eSIM 208, that the reserve eSIM 208 is available. An authorized application can request use of the reserve eSIM 208. In some cases, the dynamic reserve eSIM management module 504 can send a message to the wireless circuitry 110 and/or the eUICC 108 to disable one or more user eSIMs 208 before subsequently sending a second message to transition the reserve eSIM 208 from an inactive state to an active state. A fallback connectivity agent in the applications processor 512 can be enabled that allows use of the reserve eSIM 208. An authorized application can request network access, e.g., to communicate data via a wireless connection, and the fallback connectivity agent can establish a restricted functionality network connection via the reserve eSIM 208 for the authorized application, which can use the restricted functionality network connection to communicate data.

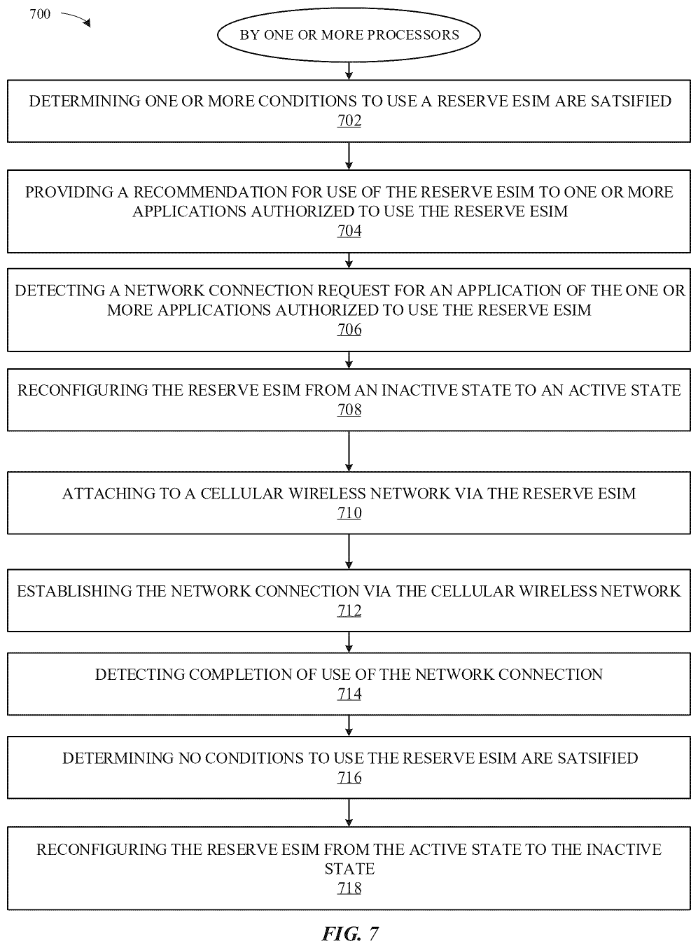

FIG. 7 illustrates a flowchart 700 of an exemplary method to manage dynamically a reserve eSIM 208 At 702, one or more processors 104 determine one or more conditions to use a reserve eSIM 208 are satisfied. At 704, the one or more processors 104 provide a recommendation for use of the reserve eSIM 208 to one or more applications 514 authorized to use the reserve eSIM 208. At 706, the one or more processors 104 detect a request for a network connection from an application of the one or more applications authorized to use the reserve eSIM 208. At 708, the one or more processors 104 reconfigure the reserve eSIM 208 from an inactive state to an active state. At 710, the one or more processors 104 attach to a cellular wireless network via the reserve eSIM 208. At 712, the one or more processors 104 establish the network connection via the cellular wireless network. At 714, the one or more processors 104 detect completion of use of the network connection. At 716, the one or more processors 104 determine that no conditions to use the reserve eSIM 208 are satisfied. At 718, the one or more processors 104 reconfigure the reserve eSIM 208 from the active state to the inactive state.

In some embodiments, the method performed by the one or more processors 104 further includes the one or more processors 104 disabling one or more active user eSIMs 208 on the eUICC 108 of the wireless device 102 prior to reconfiguring the reserve eSIM 208 from the inactive state to the active state. In some embodiments, the one or more processors 104 maintain attachment to the wireless network via the reserve eSIM 208 when at least one condition to use the reserve eSIM 208 is satisfied. In some embodiments, the one or more conditions to use the reserve eSIM 208 are satisfied when i) at least one user eSIM 208 is installed on the eUICC 108, ii) no cellular wireless connection via the at least one user eSIM 208 can be established, and iii) no Internet connectivity is available via a non-cellular wireless connection. In some embodiments, the one or more processors 104 determine no Internet connectivity is available via the non-cellular wireless connection based on i) detecting repeated connection failures over a continuous time period satisfying a time threshold, and ii) detecting an unsuccessful probe resulting from sending one or more packets to a known endpoint after detection of the repeated connection failures. In some embodiments, the reserve eSIM 208 is restricted for use, by the one or more applications, to one or more authorized tasks. In some embodiments, the one or more authorized tasks include provisioning of a new user eSIM 208 to the eUICC 108. In some embodiments, the one or more authorized tasks include managing a cellular wireless subscription account associated with a user eSIM 208 installed on the eUICC 108.

### Representative Device

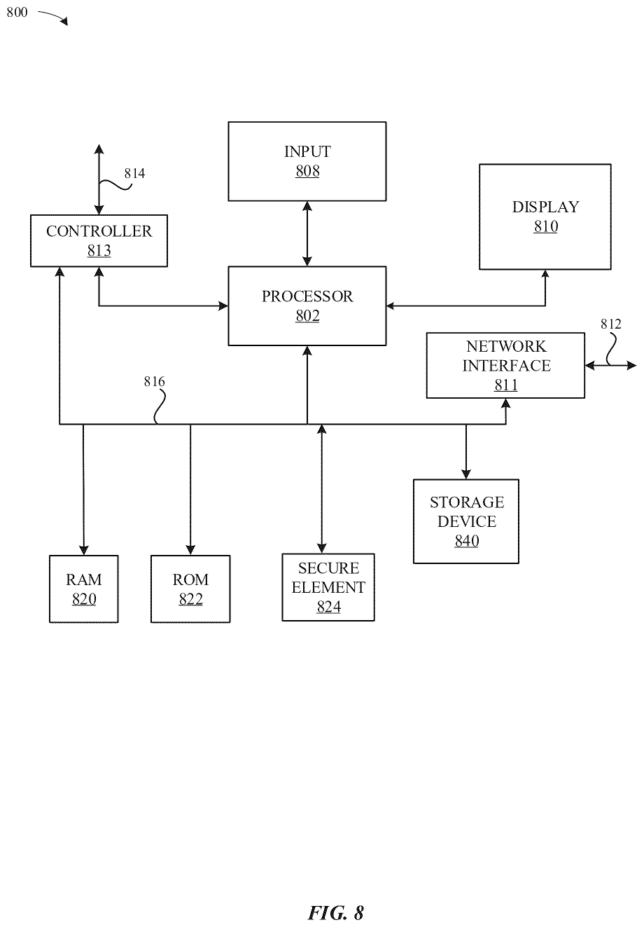

FIG. 8 illustrates a detailed view of a representative computing device 800 that can be used to implement various methods described herein, according to some embodiments. In particular, the detailed view illustrates various components that can be included in the wireless device 102. As shown in FIG. 8, the computing device 800 can include a processor 802 that represents a microprocessor or controller for controlling the overall operation of computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, etc. Still further, the computing device 800 can include a display 810 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that communicatively couples to a data link 812. In the case of a wireless connection, the network/bus interface 811 can include a wireless transceiver.

The computing device 800 also includes a storage device 840, which can comprise a single disk or a plurality of disks (e.g., hard drives), and includes a storage management module that manages one or more partitions within the storage device 840. In some embodiments, storage device 840 can include flash memory, semiconductor (solid state) memory or the like. The computing device 800 can also include a Random Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800. The computing device 800 can further include a secure element (SE) 824, which can represent secure storage for cellular wireless system access by the wireless device 102, such as an eUICC 108 on which to store one or more eSIMs 208 and/or a UICC 118 on which to store a pSIM profile.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for dynamic management of a reserve electronic subscriber identity module (eSIM) installed on an embedded universal integrated circuit card (eUICC), the method comprising:
by one or more processors:
determining one or more conditions to use the reserve eSIM are satisfied;
providing a recommendation for use of the reserve eSIM to one or more applications authorized to use the reserve eSIM;
detecting a network connection request for an application of the one or more applications authorized to use the reserve eSIM;
reconfiguring the reserve eSIM from an inactive state to an active state; and
attaching to a wireless network via the reserve eSIM.

2. The method of claim 1, further comprising:
disabling one or more active user eSIMs on the eUICC prior to reconfiguring the reserve eSIM from the inactive state to the active state.

3. The method of claim 1, further comprising:
establishing a network connection for the application via the reserve eSIM;
detecting completion of use of the network connection by the application; and
determining whether to maintain use of the reserve eSIM based on monitoring the one or more conditions to use the reserve eSIM.

4. The method of claim 3, further comprising:
reconfiguring the reserve eSIM from the active state to the inactive state when no conditions to use the reserve eSIM are satisfied.

5. The method of claim 3, further comprising:
maintaining attachment to the wireless network via the reserve eSIM when at least one condition to use the reserve eSIM is satisfied.

6. The method of claim 1, wherein:
the one or more conditions to use the reserve eSIM are satisfied when i) at least one user eSIM is installed on the eUICC, ii) no cellular wireless connection via at least one user eSIM can be established, and iii) no Internet connectivity is available via a non-cellular wireless connection.

7. The method of claim 6, further comprising:
determining no Internet connectivity is available via the non-cellular wireless connection based on i) detecting repeated connection failures over a continuous time period satisfying a time threshold, and ii) detecting an unsuccessful probe resulting from sending one or more packets to a known endpoint after detection of the repeated connection failures.

8. The method of claim 1, wherein the reserve eSIM is restricted for use, by the one or more applications, to one or more authorized tasks.

9. The method of claim 8, wherein the one or more authorized tasks include provisioning of a new user eSIM to the eUICC.

10. The method of claim 8, wherein the one or more authorized tasks include managing a cellular wireless subscription account associated with a user eSIM installed on the eUICC.

11. A wireless device comprising:
wireless circuitry comprising one or more antennas and an embedded universal integrated circuit card (eUICC); and
one or more processors communicatively coupled to the wireless circuitry and to a memory storing instructions that, when executed by the one or more processors, configure the wireless device to:
determine one or more conditions to use the reserve eSIM are satisfied;
provide a recommendation for use of the reserve eSIM to one or more applications authorized to use the reserve eSIM;
detect a network connection request for an application of the one or more applications authorized to use the reserve eSIM;
reconfigure the reserve eSIM from an inactive state to an active state; and
attach the wireless device to a wireless network via the reserve eSIM.

12. The wireless device of claim 11, wherein the wireless device is further configured to:
establish a network connection for the application via the reserve eSIM;
detect completion of use of the network connection by the application; and
determine whether to maintain use of the reserve eSIM based on monitoring the one or more conditions to use the reserve eSIM.

13. The wireless device of claim 12, wherein the wireless device is further configured to:
reconfigure the reserve eSIM from the active state to the inactive state when no conditions to use the reserve eSIM are satisfied.

14. The wireless device of claim 12, wherein the wireless device is further configured to:
maintain attachment to the wireless network via the reserve eSIM when at least one condition to use the reserve eSIM is satisfied.

15. The wireless device of claim 11, wherein:
the one or more conditions to use the reserve eSIM are satisfied when i) at least one user eSIM is installed on the eUICC, ii) no cellular wireless connection via at least one user eSIM can be established, and iii) no Internet connectivity is available via a non-cellular wireless connection.

16. The wireless device of claim 15, wherein the wireless device is further configured to:
determine no Internet connectivity is available via the non-cellular wireless connection based on i) detecting repeated connection failures over a continuous time period satisfying a time threshold, and ii) detecting an unsuccessful probe resulting from sending one or more packets to a known endpoint after detection of the repeated connection failures.

17. The wireless device of claim 11, wherein the reserve eSIM is restricted for use, by the one or more applications to one or more authorized tasks.

18. The wireless device of claim 17, wherein the one or more authorized tasks include provisioning of a new user eSIM to the eUICC of the wireless device.

19. The wireless device of claim 17, wherein the one or more authorized tasks include managing a cellular wireless subscription account associated with a user eSIM installed on the eUICC of the wireless device.

20. One or more processors for dynamic management of a reserve electronic subscriber identity module (eSIM) on an embedded universal integrated circuit card (eUICC), wherein the one or more processors are configured to:
determine one or more conditions to use the reserve eSIM are satisfied;
provide a recommendation for use of the reserve eSIM to one or more applications authorized to use the reserve eSIM;
detect a network connection request for an application of the one or more applications authorized to use the reserve eSIM;
reconfigure the reserve eSIM from an inactive state to an active state; and
attach to a wireless network via the reserve eSIM.
